(19) United States
(12) Patent Application Publication
(10) Pub. No.: US 2012/0215374 A1
(43) Pub. Date: Aug. 23, 2012

(54) Electronic Apparatus and Positioning Method Thereof

(76) Inventor: Sip Kim Yeung, Hsichih (TW)

(21) Appl. No.: 13/215,282

(22) Filed: Aug. 23, 2011

(30) Foreign Application Priority Data
Feb. 23, 2011 (TW) 100106038

(51) Int. Cl. G05D 3/12

(52) U.S. Cl. 700/302

(57) ABSTRACT

A positioning method applicable to a first electronic apparatus with an induction coil module is disclosed. The method comprises: determining whether a second electronic apparatus is approaching the first electronic apparatus and located within a specific distance of the first electronic apparatus to generate a detection result; performing data transmission between the second electronic apparatus and the induction coil module, and generating a positioning information when the detection result indicates that the second electronic apparatus is located within the specific distance of the first electronic apparatus, wherein the positioning information comprises a first address information and a first time information of the first electronic apparatus, and a second address information and a second time information of the second electronic apparatus which are obtained by the induction coil module; and sending the positioning information to a server end to complete the positioning process between the first electronic apparatus and the second electronic apparatus.

### BACKGROUND OF THE INVENTION

1. Field of the Invention

The present invention relates to positioning methods, and more particularly, to a positioning method for completing a positioning process of an apparatus by performing data transmission via an induction coil. The present invention further comprises an electronic apparatus for use with the method.

2. Description of the Prior Art

A portable electronic apparatus having a global positioning system (GPS) function is used outdoors by a user mostly in a positioning and searching process between the apparatus and another apparatus. However, once the user enters an indoor environment, such as a building, the building will block the access to satellite signals and therefore prevent the GPS function from operating. Therefore, another mechanism is required for positioning or searching an apparatus indoors. Take an indoor wireless network as an example, to enable two conventional portable electronic apparatuses to position each other, each user has to input to his/her apparatus related information, such as the MAC address of the other user's apparatus. The users have to take the aforesaid operation steps repeatedly in order to position different users' conventional portable electronic apparatuses. This causes inconvenience to the users.

Furthermore, some conventional portable electronic apparatuses each have an induction coil therein for charging the apparatus per se by means of the electromagnetic induction produced between the induction coil and a charging apparatus corresponding in position thereto. However, in general, the aforesaid induction coils serve a charging purpose only. Accordingly, in this regard, a good topic for research is: making good use of the aforesaid induction coils and applying the aforesaid induction coils to perform the positioning operation.

### SUMMARY OF THE INVENTION

It is a primary objective of the present invention to provide a positioning method for effectuating the position of an apparatus, by using an induction coil to perform data transmission.

In order to achieve the above and other objectives, the present invention provides a positioning method applicable to a first electronic apparatus with an induction coil module. The method comprises: determining whether a second electronic apparatus is approaching the first electronic apparatus and located within a specific distance of the first electronic apparatus to generate a detection result; performing data transmission between the second electronic apparatus and the induction coil module, and generating a positioning information when the detection result indicates that the second electronic apparatus is located within the specific distance, wherein the positioning information comprises a first address information and a first time information of the first electronic apparatus, and a second address information and a second time information of the second electronic apparatus which are obtained by means of the induction coil module; and sending the positioning information to a server end to complete the positioning process between the first electronic apparatus and the second electronic apparatus.

The present invention further provides an electronic apparatus for use with the positioning method. The electronic apparatus of the present invention performs a positioning process of a target electronic apparatus, and comprises an induction coil module, a detecting module, a processing module, and a communicating module. The induction coil module performs data transmission between the induction coil module and the target electronic apparatus by way of electromagnetic induction. The detecting module detects whether the target electronic apparatus is approaching the electronic apparatus and located within a specific distance of the electronic apparatus to generate a detection result. The processing module performs data transmission between the induction coil module and the target electronic apparatus and generates a positioning information according to the detection result of the detecting module, wherein the positioning information comprises a first time information and a first address information of the electronic apparatus, and a second time information and a second address information of the target electronic apparatus which are obtained by the induction coil module. The communicating module sends the positioning information to a server end to complete the positioning process between the electronic apparatus and the target electronic apparatus.

According to the present invention, electronic apparatuses each having an induction coil for transmitting essential positioning information can be perform a positioning process each other so as to bring convenience to users. Afterward, each electronic apparatus can obtain information, such as the location or movement track of a target electronic apparatus to be searched for, by a server end, thereby enhancing ease of use.

### BRIEF DESCRIPTION OF THE DRAWINGS

To enable persons skilled in the art to fully understand the objectives, technical disclosures, features, and attainable advantages of the present invention, the present invention is hereunder illustrated with specific embodiments in conjunction with the accompanying drawings, in which:

FIG. 1 is a system block diagram of an electronic apparatus according to the first embodiment of the present invention;

FIG. 2 is a flowchart of a positioning method according to the first embodiment of the present invention;

FIG. 3 is a system block diagram of an electronic apparatus according to the second embodiment of the present invention;

FIG. 4 is a flowchart of a positioning method according to the second embodiment of the present invention;

FIG. 5 is a flowchart of a positioning method according to the third embodiment of the present invention; and

FIG. 6 is a flowchart of a positioning method according to the fourth embodiment of the present invention.

### DETAILED DESCRIPTION OF THE EMBODIMENTS

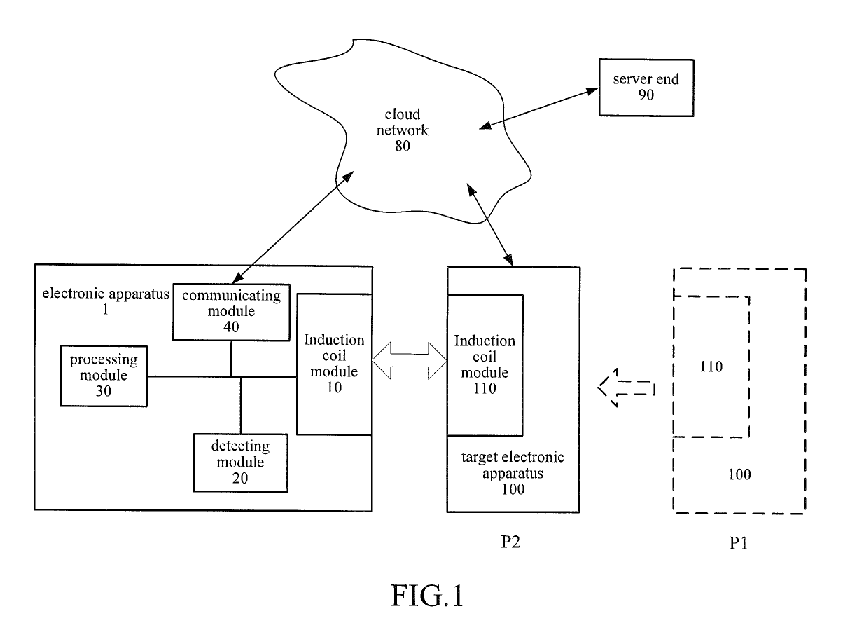

Referring to FIG. 1, there is shown a system block diagram of an electronic apparatus 1 according to the first embodiment of the present invention. The electronic apparatus 1 of the present invention is for performing a positioning process of a target electronic apparatus. The aforesaid electronic apparatus or the aforesaid target electronic apparatus is a common portable electronic apparatus, such as a notebook computer, a panel computer, a smartphone, a personal digital assistant, or the like; however, the first embodiment does not limit the present invention.

As shown in FIG. 1, the electronic apparatus 1 of the present invention comprises an induction coil module 10, a detecting module 20, a processing module 30, and a communicating module 40. The processing module 30 and the other constituent elements of the electronic apparatus 1 are electrically connected to each other by a bus, a circuit, or any means. The induction coil module 10 performs data transmission between the induction coil module 10 and a target electronic apparatus 100 by way of electromagnetic induction. The target electronic apparatus 100 also comprises an induction coil module 110. When the electronic apparatus 1 of the present invention and the target electronic apparatus 100 get sufficiently close to each other, the induction coil modules 10, 110 generate electromagnetic induction toward each other and thereby are capable of data transmission. The data to be transmitted undergo phase shift when subjected to signal processing; hence, the meanings of the different phases configured tell the contents of the data transmitted. Transmission of data by means of an induction coil is a known technique and thus is not described hereunder for the sake of brevity. Furthermore, in an embodiment of the present invention, the induction coil module 10 may use an well-known induction charging coil for charging to achieve the technical effect of the present invention, but this embodiment is not restrictive of the present invention.

The detecting module 20 is electrically connected to the induction coil module 10 to detect a current change produced by the induction coil module 10. The detecting module 20 has a specific distance range of detection. Assuming that, initially, the target electronic apparatus 100 lies at a location P1 that falls outside the specific distance range of detection and therefore cannot be detected by the detecting module 20. Once the target electronic apparatus 100 moves to a location P2 lying within the specific distance range of detection to thereby allow the induction coil module 110 of the target electronic apparatus 100 and the induction coil module 10 of the electronic apparatus 1 of the present invention to get sufficiently close to each other, the detecting module 20 determines the target electronic apparatus 100 is approaching the electronic apparatus 1 and located within a specific distance to generate a detection result according to the current change produced by the induction coil module 10. Then the detecting module 20 generates a detection result to notify the processing module 30 to perform a subsequent operation. The aforesaid specific distance between the aforesaid apparatuses is typically several centimeters for the operation of an induction coil.

The processing module 30 performs data transmission between the induction coil module 10 and the target electronic apparatus 100 according to the detection result of the detecting module 20. The processing module 30 not only obtains related apparatus information of the target electronic apparatus 100 but also performs signal processing on the data (to be transmitted) of the electronic apparatus 1, in order to transmit related apparatus information of the electronic apparatus 1 to the target electronic apparatus 100. The processing module 30 generates a positioning information according to the apparatus information of the electronic apparatus 1 and the apparatus information of the target electronic apparatus 100. The positioning information comprises a first time information and a first address information of the electronic apparatus 1 and a second time information and a second address information of the target electronic apparatus 100 which are obtained by the induction coil module 10.

The first time information corresponds to a time point when the electronic apparatus 1 performs the aforesaid data transmission. The time point should, when in doubt, match the apparatus time set by the electronic apparatus 1 for computation. The second time information corresponds to a time point when the target electronic apparatus 100 performs the aforesaid data transmission. The time point should, when in doubt, match the apparatus time set by the target electronic apparatus 100 for computation. Hence, the first time information and the second time information are not necessarily identical. The first address information comprises the MAC address or the International Mobile Equipment Identification (IMEI) of the electronic apparatus 1. The second address information comprises the MAC address or the IMEI of the target electronic apparatus 100. However, the above disclosure is not restrictive of the present invention.

The communicating module 40 sends the positioning information to a server end 90 to complete the positioning process between the electronic apparatus 1 and the target electronic apparatus 100. The communicating module 40 performs data transmission and communication with the server end 90 by means of a cloud network 80 (such as cloud or clear.fi). A point to note is that the detecting module 20, the processing module 30 and the communicating module 40 of the electronic apparatus 1 of the present invention can perform their functions by being implemented in the form of hardware, software, firmware, or a combination of at least two of the above, and the present invention is not limited thereto.

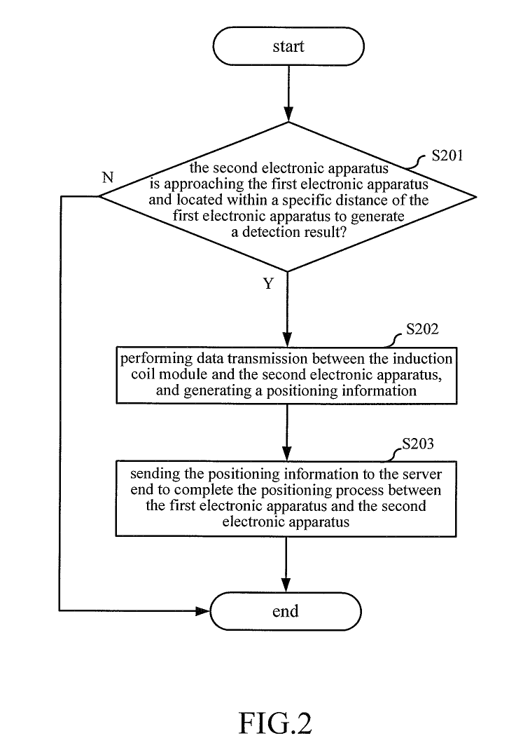

Referring to FIG. 2, there is shown a flowchart of a positioning method according to the first embodiment of the present invention. A point to note is that, although the positioning method in the first embodiment of the present invention is illustrated with the electronic apparatus 1 shown in FIG. 1, the present invention is not limited thereto, as any electronic apparatus of a structure similar to that of the electronic apparatus 1 is also applicable to the positioning method of the present invention. In the description of the positioning method below, the electronic apparatuses are named a first electronic apparatus (equivalent to the electronic apparatus 1) and a second electronic apparatus (equivalent to the target electronic apparatus 100), respectively, for the purpose of differentiation. As shown in FIG. 2, the positioning method of the present invention comprises step S201 through step S203. The steps of the positioning method of the present invention are described in detail below.

Step S201: determining whether the second electronic apparatus is approaching the first electronic apparatus and located within a specific distance of the first electronic apparatus to generate a detection result. The first electronic apparatus determines whether the second electronic apparatus is approaching the first electronic apparatus by means of the detecting module 20 to detect the current generated by the induction coil module 10. Once the induction coil module 110 of the second electronic apparatus approaches the induction coil module 10 of the first electronic apparatus and located within a specific distance of the first electronic apparatus, the induction coil module 10 will generate an induction current by way of electromagnetic induction. After detecting the current change, the detecting module 20 may generate a detection result to notify the processing module 30.

Step S202: performing data transmission between the induction coil module 10 and the second electronic apparatus, and generating a positioning information when the detection result indicates that the second electronic apparatus is located within the specific distance of the first electronic apparatus. When the processing module 30 receives the detection result indicates that the second electronic apparatus is located within the specific distance of the first electronic apparatus, the processing module 30 decides to perform data transmission. Meanwhile, the time point of the first electronic apparatus is recorded as the first time information, and the MAC address of the first electronic apparatus is obtained as the first address information. The aforesaid information of the first electronic apparatus is performed a signal processing process and is transmitted by the induction coil module 10 to the second electronic apparatus by way of electromagnetic induction. The second electronic apparatus also records a time point as the second time information when the second apparatus decides to perform data transmission, and its MAC address is obtained as the second address information. Then the aforesaid information of the second electronic apparatus is transmitted by the induction coil module 10 to the first electronic apparatus.

After receiving the related apparatus information of the second electronic apparatus, the processing module 30 generates a positioning information according to the first time information, the first address information, the second time information, and the second address information so as to enable a subsequent positioning and processing process to take place. Of course, after receiving the related apparatus information of the first electronic apparatus, the second electronic apparatus also generates a corresponding positioning information.

Step S203: sending the positioning information to the server end 90 to complete the positioning process between the first electronic apparatus and the second electronic apparatus. After generating the positioning information, the processing module 30 sends the positioning information to the server end 90 via the communicating module 40 and the cloud network 80 for storage. Then the processing module 30 may obtain related information from the server end 90 through the cloud network 80 when performing a searching process for the second electronic apparatus. The server end 90, such as a computer system, is an apparatus for supporting the cloud network 80 and storing data.

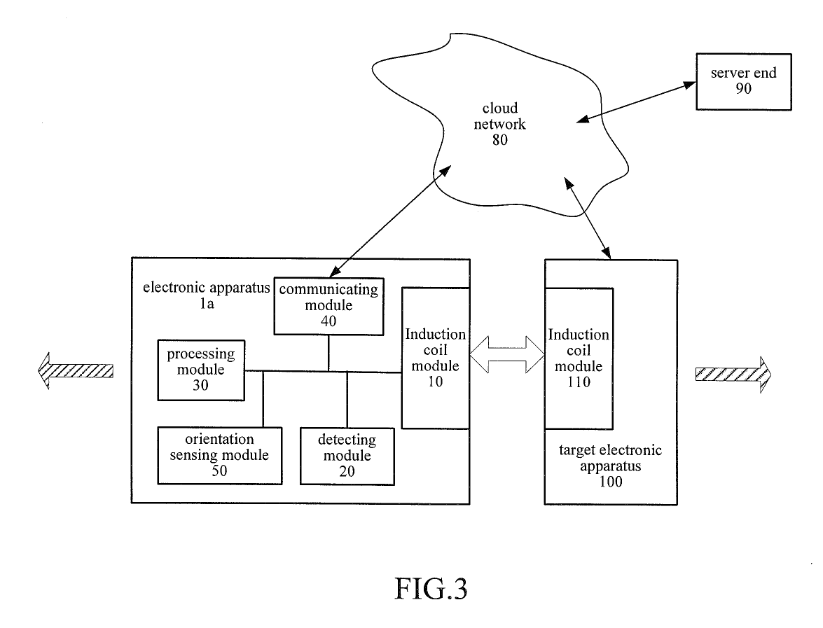

Referring to FIG. 3, there is shown a system block diagram of an electronic apparatus 1a according to the second embodiment of the present invention. As shown in FIG. 3, the electronic apparatus 1a of the present invention further comprises an orientation sensing module 50. The orientation sensing module 50 comprises at least one of an accelerometer (such as a G-sensor), a magnetometer (such as an e-compass), and a gyroscope. The orientation sensing module 50 can sense the three-dimensional orientation of the electronic apparatus 1a in a space by combining the aforesaid sensing elements. The orientation information is provided via the communicating module 40 to the server end 90 to be updated therein in real time, so as to calculate the location, movement track or distance of the electronic apparatus 1a for future use.

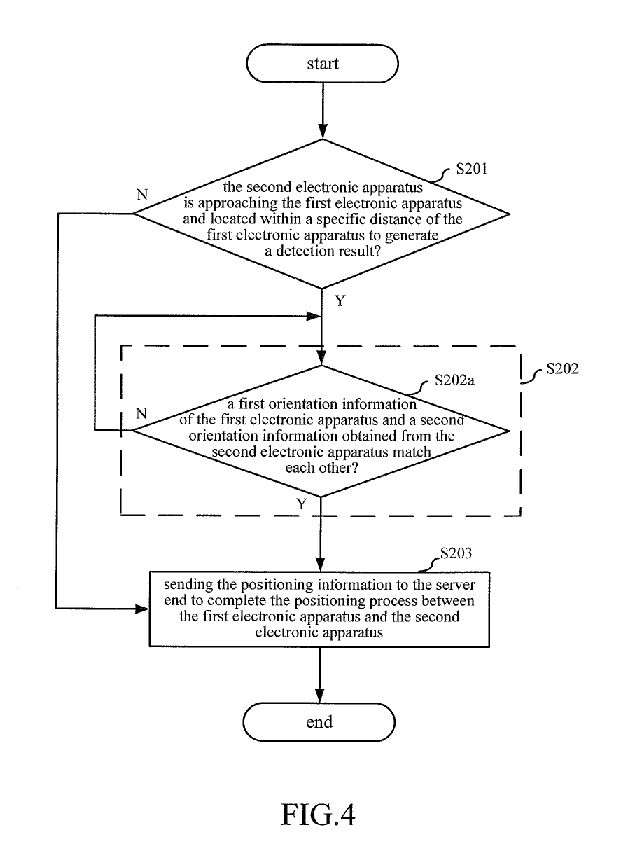

Referring to FIG. 4, there is shown a flowchart of a positioning method according to the second embodiment of the present invention. Although the positioning method in the second embodiment of the present invention is illustrated with the electronic apparatus 1a shown in FIG. 3, the present invention is not limited thereto. In the description of the positioning method below, the electronic apparatuses are named a first electronic apparatus (equivalent to the electronic apparatus 1a) and a second electronic apparatus (equivalent to the target electronic apparatus 100), respectively, for the purpose of differentiation. As shown in FIG. 4, in this embodiment, step S202 of the positioning method of the present invention further comprises step S202a: determining whether a first orientation information of the first electronic apparatus and a second orientation information obtained from the second electronic apparatus match each other. The first electronic apparatus senses the first orientation information of the first electronic apparatus via the orientation sensing module 50. Also, the first electronic apparatus obtains the second orientation information from the second electronic apparatus via the induction coil module 10.

The first orientation information and the second orientation information are each a vector substantially perpendicular to the surface of the corresponding apparatus in a space. The vectors are directional (as indicated by hatched arrows in FIG. 3). The processing module 30 determines whether the first orientation information and the second orientation information are two vectors of opposite directions, so as to ensure the correctness of the relative positions of the first electronic apparatus and the second electronic apparatus while performing data transmission. If the first orientation information and the second orientation information are two vectors of opposite directions, the method goes to step S203 to perform the positioning process. the first orientation information and the second orientation information are not two vectors of opposite directions, the step S202 is executed again, and a message is sent to notify the user to adjust the relative position of the first electronic apparatus.

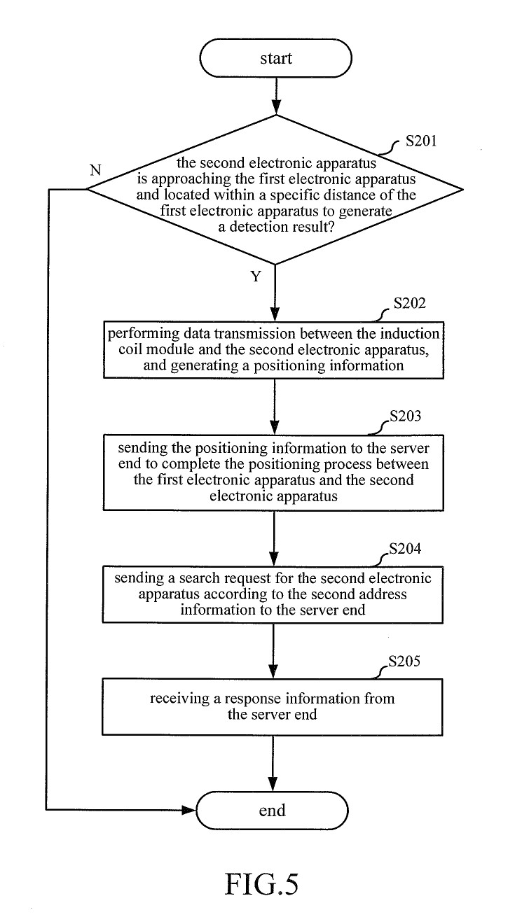

Referring to FIG. 5, there is shown a flowchart of a positioning method according to the third embodiment of the present invention. As shown in FIG. 5, in this embodiment, after step S203, the positioning method of the present invention further comprises step S204 through step S205.

Step S204: sending a search request for the second electronic apparatus according the second address information to the server end 90. After the completion of the preceding positioning step, if the processing module 30 receives an instruction inputted by a user for searching for the second electronic apparatus, the processing module 30 will notify the communicating module 40 to send a corresponding search request to the server end 90, to query about a related information, such as the location or movement status of the second electronic apparatus. The search request comprises the second address information of the second electronic apparatus, to enable the server end 90 to identify and search for the second electronic apparatus.

Step S205: receiving a response information from the server end 90. The server end 90 searches for and obtains a response information according to the search request sent from the first electronic apparatus. The response information comprises an information corresponds to the position of the second electronic apparatus at a time point when the search request is sent out, and is sent back to the first electronic apparatus to display the relative position of the second electronic apparatus. In the aforesaid performing process, the performing information comprises the first time information of the first electronic apparatus and the second time information of the second electronic apparatus; hence, a time point for the server end 90 obtaining an location information of the second electronic apparatus may be calibrated according to a difference between the first time information and the second time information to thereby ensure the correctness of the obtained location information.

For example, assuming that the first electronic apparatus determines that the first time information for performing data transmission is 1:05; meanwhile, the second time information of the second electronic apparatus is 1:07; hence, the time difference between the first time information and the second time information is 0:02. At 1:38, the first electronic apparatus sends out the search request to search for the location of the second electronic apparatus, thereby causing the server end 90 to search for the location of the second electronic apparatus at 1:40 according to the aforesaid calibrated time difference rather than search for its location at 1:38. It may ensure the correctness of the response information corresponded to the location of the second electronic apparatus.

Also, the response information further comprises a movement track information corresponded to a movement path track of the second electronic apparatus before the time point of sending out a search request. Hence, the electronic apparatus 1 can not only display the movement path of the second electronic apparatus but also obtain the relative positions of the second electronic apparatus and the electronic apparatus at each time point. The time point of the movement track information can also be calibrated in accordance with the difference between the first time information and the second time information.

According to the aforesaid design, once the induction coil modules of the apparatuses of a user A and another user B come into close contact with each other to readily complete the positioning process each other, it will be easy for the user A to know whereabouts of the user B. For example, to find the location of user B, the user A can send a search request to a server end by the Internet and obtain the location or the movement track of the user B.

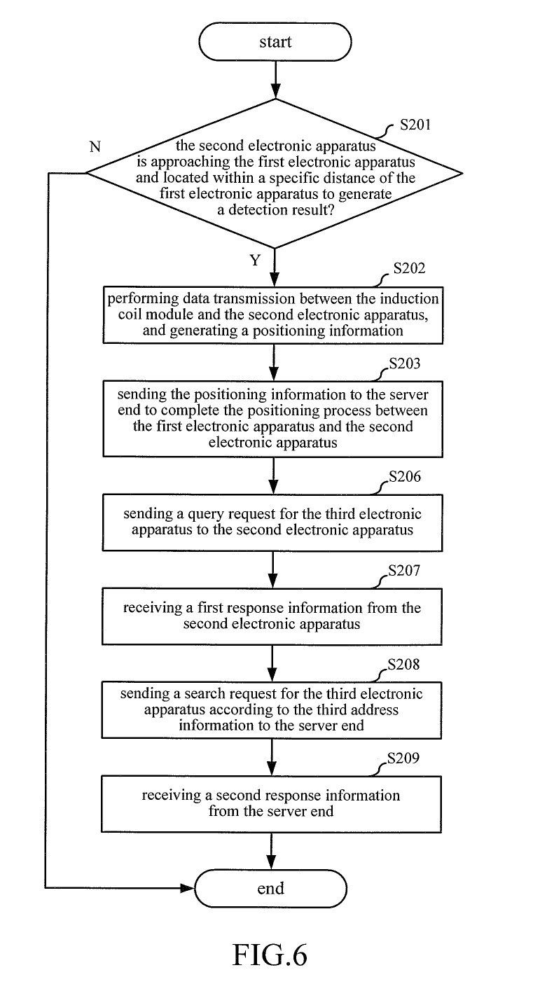

Referring to FIG. 6, there is shown a flowchart of a positioning method according to the fourth embodiment of the present invention. As shown in FIG. 6, in this embodiment, after step S203, the positioning method of the present invention further comprises step S206 through step S209. In the description of the positioning method below, the electronic apparatuses are named the first electronic apparatus (equivalent to the electronic apparatus 1 or 1a), the second electronic apparatus (equivalent to the target electronic apparatus 100), and a third electronic apparatus, respectively, for the purpose of differentiation.

Step S206: sending a query request for the third electronic apparatus to the second electronic apparatus. Assuming that the first electronic apparatus and the second electronic apparatus have completed the positioning process in the preceding step, and the second electronic apparatus and a third electronic apparatus have also completed the positioning process. When the user wants to use the first electronic apparatus to search for the third electronic apparatus which has not yet performed the positioning process, he or she has to enter a related search instruction for the third electronic apparatus. After receiving the related search instruction for the third electronic apparatus, the processing module 30 notifies the communicating module 40 to send a query request to the second electronic apparatus to ask whether the second electronic apparatus has a related apparatus information of the third electronic apparatus.

Step S207: receiving a first response information from the second electronic apparatus. Once the positioning process of the second electronic apparatus and the third electronic apparatus is completed, the second electronic apparatus will send back the first response information to the first electronic apparatus according to the query request, wherein the first response information comprises a third address information of the third electronic apparatus.

Step S208: sending a search request for the third electronic apparatus according to the third address information to the server end 90. After the preceding step, if the processing module 30 obtains the third address information of the third electronic apparatus, the processing module 30 will notify the communicating module 40 to send the search request of the third electronic apparatus to the server end 90 to query related information, such as the location or the movement status of the third electronic apparatus.

Step S209: receiving a second response information from the server end 90. The server end 90 searches for and obtains the second response information according to the search request sent from the first electronic apparatus, wherein the second response information comprises the location of the third electronic apparatus at the time point when the search request is sent out, and is sent back to the first electronic apparatus to display the relative location of the third electronic apparatus.

According to the aforesaid design, assuming that the apparatuses of a user A and another user B complete the positioning process each other; if the user B completes the positioning process with any user C, the user A can search and find the user C through the user B to obtain the location or the movement track of the user C to enhance ease of use.

The foregoing embodiments are provided to illustrate and disclose the technical notions and features of the present invention so as to enable persons skilled in the art to understand the disclosure of the present invention and implement the present invention accordingly, and are not intended to be restrictive of the scope of the present invention. Hence, all equivalent variations or modifications made in the foregoing embodiments without departing from the spirit embodied in the disclosure of the present invention should fall within the scope of the present invention as set forth in the appended claims.

What is claimed is:

1. An electronic apparatus for performing a positioning process of a target electronic apparatus, the electronic apparatus comprising:
an induction coil module, arranged for performing data transmission between the induction coil module and the target electronic apparatus by way of electromagnetic induction;
a detecting module, arranged for detecting whether the target electronic apparatus is approaching the electronic apparatus and located within a specific distance of the electronic apparatus to generate a detection result;
a processing module, arranged for performing data transmission between the induction coil module and the target electronic apparatus and generating a positioning information according to the detection result of the detecting module, wherein the positioning information comprises a first time information and a first address information of the electronic apparatus, and a second time information and a second address information of the target electronic apparatus which are obtained by the induction coil module; and
a communicating module, arranged for sending the positioning information to a server end to complete the positioning process between the electronic apparatus and the target electronic apparatus.

2. The electronic apparatus of claim 1, wherein the first time information corresponds to a time point when the electronic apparatus performs the data transmission, and the second time information corresponds to a time point when the target electronic apparatus performs the data transmission.

3. The electronic apparatus of claim 1, wherein the first address information comprises a MAC address or an International Mobile Equipment Identification (IMEI) of the electronic apparatus, and the second address information comprises a MAC address or an IMEI of the target electronic apparatus.

4. The electronic apparatus of claim 1, wherein the processing module is further arranged for transmitting the first address information and the first time information to the target electronic apparatus by the induction coil module so as to performing the positioning process of the target electronic apparatus.

5. The electronic apparatus of claim 1, further comprising an orientation sensing module for sensing a first orientation information of the electronic apparatus.

6. The electronic apparatus of claim 5, wherein the orientation sensing module comprises at least one of an accelerometer, a gyroscope, and a magnetometer for sensing a three-dimensional orientation of the electronic apparatus in a space.

7. The electronic apparatus of claim 5, wherein the processing module is further arranged for determining whether locations of the electronic apparatus and the target electronic apparatus match according to the first orientation information and a second orientation information obtained from the target electronic apparatus.

8. The electronic apparatus of claim 1, wherein the processing module is further notifying the communicating module to send a search request for the target electronic apparatus to the server end and receiving a response information from the server end, wherein the response information corresponds to a location of the target electronic apparatus relative to the electronic apparatus when the search request is sent out.

9. The electronic apparatus of claim 8, wherein the response information further comprises a movement track information corresponded to a movement path track of the target electronic apparatus relative to the electronic apparatus before the search request is sent out.

10. A positioning method, applicable to a first electronic apparatus with an induction coil module, the method comprising:
determining whether a second electronic apparatus is approaching the first electronic apparatus and located within a specific distance of the first electronic apparatus to generate a detection result;
performing data transmission between the second electronic apparatus and the induction coil module, and generating a positioning information when the detection result indicates that the second electronic apparatus is located within the specific distance of the first electronic apparatus, wherein the positioning information comprises a first address information and a first time information of the first electronic apparatus, and a second address information and a second time information of the second electronic apparatus which are obtained by the induction coil module; and
sending the positioning information to a server end to complete the positioning process between the first electronic apparatus and the second electronic apparatus.

11. The method of claim 10, wherein the first time information corresponds to a time point when the first electronic apparatus performs the data transmission, and the second time information corresponds to a time point when the second electronic apparatus performs the data transmission.

12. The method of claim 10, wherein the first address information comprises a MAC address or an International Mobile Equipment Identification (IMEI) of the first electronic apparatus, and the second address information comprises a MAC address or an IMEI of the second electronic apparatus.

13. The method of claim 10, wherein the step of performing data transmission between the second electronic apparatus and the induction coil module further comprises: transmitting the first address information and the first time information to the second electronic apparatus by the induction coil module so as to performing the positioning process of the second electronic apparatus.

14. The method of claim 10, further comprising:
determining whether a first orientation information of the first electronic apparatus and a second orientation information obtained from the second electronic apparatus match each other.

15. The method of claim 10, further comprising:
sending a search request for the second electronic apparatus according to the second address information to the server end; and
receiving a response information from the server end, wherein the response information comprises a location of the second electronic apparatus relative to the first electronic apparatus when the search request is sent out.

16. The method of claim 12, wherein the response information further comprises a movement track information corresponded to a movement path track of the second electronic apparatus relative to the first electronic apparatus before the search request is sent out.

17. The method of claim 10, further comprising:
sending a query request for a third electronic apparatus to the second electronic apparatus;
receiving a first response information from the second electronic apparatus, wherein the first response information comprises a third address information of the third electronic apparatus;
sending a search request for the third electronic apparatus according to the third address information to the server end; and
receiving a second response information from the server end, wherein the second response information comprises a location of the third electronic apparatus relative to the first electronic apparatus when the search request is sent out.

18. The method of claim 17, wherein the second response information further comprises a movement track information corresponded to a movement path track of the third electronic apparatus relative to the first electronic apparatus before the search request is sent out.
